(19) United States
(12) Patent Application Publication
(10) Pub. No.: US 2026/0339246 A1
(43) Pub. Date: Oct. 29, 2026

(54) HEATER AND IMAGE HEATING APPARATUS

(71) Applicant: CANON KABUSHIKI KAISHA, Tokyo (JP)

(72) Inventors: YUJI FUJIWARA, Tokyo (JP); TAKAO KAWAZU, Shizuoka (JP); TAKAO IZAKI, Shizuoka (JP)

(21) Appl. No.: 19/658,338

(22) Filed: Apr. 24, 2026

(30) Foreign Application Priority Data
Apr. 28, 2025 (JP) 2025-074593
Feb. 19, 2026 (JP) 2026-025638

(51) Int. Cl. G03G 15/20; G03G 15/00; H05B 3/03

(52) U.S. Cl. CPC G03G 15/2053; G03G 15/2064; G03G 15/80; H05B 3/03

(57) ABSTRACT

A heater in which first and second heat generation resistors are disposed on an elongated substrate along a longitudinal direction at positions offset toward long sides opposite from each other from a center in a lateral direction, respectively, and these resistors are connected in series via a third conductor. Exposed first and second electric contacts are provided on one end side of the substrate. The second electric contact is arranged further away from the one end than the first electric contact in the longitudinal direction, and the positions of these electric contacts overlap each other in the lateral direction. Each of the contacts and the resistor are connected via a conductor. The conductor includes a widened portion on a contact side and a tapered portion having a width reducing toward a connection position.

### BACKGROUND

### Field of the Technology

The present disclosure relates to a heater and an image heating apparatus that heats a recording material.

### Description of the Related Art

As image heating apparatuses mounted on electrophotographic copying machines and printers, there are known image heating apparatuses using a film heating method. Film heating-type fixing devices include a tubular film, a heating element in contact with the inner surface of the film, and a pressing roller that forms a nip portion together with the heating element via the film. One example generally used as the heating element is a ceramic heater including a substrate with a heat generation resistor formed thereon.

A heater described in Japanese Patent Laid-Open No. 2008-140702 includes two heat generation resistors disposed in parallel on a substrate, and two power supply electrodes (electric contacts) disposed on one longitudinal end of the substrate. It is also conceivable to employ such a configuration that the two heat generation resistors and the two power supply electrodes are connected via conductors, respectively, in a case where the sizes of the power supply electrodes are small.

Then, when the distance between the above-described conductors is shortened due to a size reduction of the substrate or the like, a leakage current may undesirably flow between the two conductors, and thermal destruction of the heater may accidentally occur if a leakage current is generated between opposite polarities.

### SUMMARY

Under these circumstances, the present disclosure is directed to providing a heater and an image heating apparatus that suppress generation of a leakage current between two conductors.

According to an aspect of the present disclosure, a heater includes an elongated substrate, the substrate having a first long side and a second long side when the heater is viewed in a direction perpendicular to a plane of the substrate, a first heat generation resistor disposed on the substrate along a longitudinal direction of the substrate, the first heat generation resistor being arranged at a position offset in a direction toward the first long side from a center of the substrate in a lateral direction of the substrate, a second heat generation resistor disposed on the substrate along the longitudinal direction, the second heat generation resistor being arranged at a position offset in a direction toward the second long side from the center in the lateral direction, a first electric contact in contact with a first terminal for power supply to the first heat generation resistor and power supply to the second heat generation resistor via the first heat generation resistor, the first electric contact being arranged at a position closer to one end of the substrate than the first heat generation resistor in the longitudinal direction, and the first electric contact being electrically connected to one end of the first heat generation resistor in the longitudinal direction, a second electric contact in contact with a second terminal for power supply to the second heat generation resistor and power supply to the first heat generation resistor via the second heat generation resistor, the second electric contact being arranged at a position closer to the one end of the substrate than the second heat generation resistor in the longitudinal direction, and the second electric contact being electrically connected to one end of the second heat generation resistor in the longitudinal direction, a first conductor disposed between the first heat generation resistor and the first electric contact in the longitudinal direction, the first conductor electrically connecting the first heat generation resistor and the first electric contact, a second conductor disposed between the second heat generation resistor and the second electric contact in the longitudinal direction, the second conductor electrically connecting the second heat generation resistor and the second electric contact, a third conductor electrically connecting another end of the first heat generation resistor opposite from the one end of the first heat generation resistor in the longitudinal direction and another end of the second heat generation resistor opposite from the one end of the second heat generation resistor in the longitudinal direction, and an insulating layer covering the first heat generation resistor, the second heat generation resistor, the first conductor, the second conductor, and the third conductor with the first electric contact and the second electric contact exposed, wherein the first heat generation resistor and the second heat generation resistor are electrically connected in series via the third conductor, the second electric contact is arranged at a position further away from the one end of the substrate than the first electric contact in the longitudinal direction, the position of the first electric contact and the position of the second electric contact overlap each other in the lateral direction, a first widened portion is provided in a region of the first conductor on a closer side to the one end of the substrate with respect to a first connection position of the first conductor with the first heat generation resistor, the first widened portion having a wider width in the lateral direction than a width of the first connection position in the lateral direction, a second widened portion is provided in a region of the second conductor on a closer side to the one end of the substrate with respect to a second connection position of the second conductor with the second heat generation resistor, the second widened portion having a wider width in the lateral direction than a width of the second connection position in the lateral direction, a first width change portion is provided in a region of the first conductor between the first widened portion and the first connection position in the longitudinal direction, the first width change portion having a width in the lateral direction that reduces from the first widened portion toward the first connection position, a second width change portion is provided in a region of the second conductor between the second widened portion and the second connection position in the longitudinal direction, the second width change portion having a width in the lateral direction that reduces from the second widened portion toward the second connection position, a side of the first width change portion that faces the first long side of the substrate is linearly shaped in parallel with the first long side, a side of the second width change portion that faces the second long side of the substrate is linearly shaped in parallel with the second long side, and a distance between the first connection position and the second connection position is longer than a distance between the first widened portion and the second widened portion in the lateral direction.

According to another aspect of the present disclosure, a heater includes an elongated substrate, the substrate having a first long side and a second long side when the heater is viewed in a direction perpendicular to a plane of the substrate, a first heat generation resistor disposed on the substrate along a longitudinal direction of the substrate, the first heat generation resistor being arranged at a position offset in a direction toward the first long side from a center of the substrate in a lateral direction of the substrate, a second heat generation resistor disposed on the substrate along the longitudinal direction, the second heat generation resistor being arranged at a position offset in a direction toward the second long side from the center in the lateral direction, a first electric contact in contact with a first terminal for power supply to the first heat generation resistor and power supply to the second heat generation resistor via the first heat generation resistor, the first electric contact being arranged at a position closer to one end of the substrate than the first heat generation resistor in the longitudinal direction, and the first electric contact being electrically connected to one end of the first heat generation resistor in the longitudinal direction, a second electric contact in contact with a second terminal for power supply to the second heat generation resistor and power supply to the first heat generation resistor via the second heat generation resistor, the second electric contact being arranged at a position closer to the one end of the substrate than the second heat generation resistor in the longitudinal direction, and the second electric contact being electrically connected to one end of the second heat generation resistor in the longitudinal direction, a first conductor disposed between the first heat generation resistor and the first electric contact in the longitudinal direction, the first conductor electrically connecting the first heat generation resistor and the first electric contact, a second conductor disposed between the second heat generation resistor and the second electric contact in the longitudinal direction, the second conductor electrically connecting the second heat generation resistor and the second electric contact, a third conductor electrically connecting another end of the first heat generation resistor opposite from the one end of the first heat generation resistor in the longitudinal direction and another end of the second heat generation resistor opposite from the one end of the second heat generation resistor in the longitudinal direction, and an insulating layer covering the first heat generation resistor, the second heat generation resistor, the first conductor, the second conductor, and the third conductor with the first electric contact and the second electric contact exposed, wherein the first heat generation resistor and the second heat generation resistor are electrically connected in series via the third conductor, the second electric contact is arranged at a position different from a position of the first electric contact in the longitudinal direction, the position of the first electric contact and the position of the second electric contact overlap each other in the lateral direction, a widened portion is provided in a region of the first conductor on a closer side to the one end of the substrate with respect to a connection position of the first conductor with the first heat generation resistor, the widened portion having a wider width in the lateral direction than a width of the connection position in the lateral direction, a width change portion is provided in a region of the first conductor between the widened portion and the connection position in the longitudinal direction, the width change portion having a width in the lateral direction that reduces from the widened portion toward the connection position, a side of the width change portion that faces the first long side of the substrate is linearly shaped in parallel with the first long side, a side of the second conductor facing the second long side of the substrate and located in the same region as the width change portion in the longitudinal direction is linearly shaped in parallel with the second long side, and a distance between the connection position of the first conductor with the first heat generation resistor and a connection position of the second conductor with the second heat generation resistor in the lateral direction is longer than a distance between the widened portion and a region of the second conductor that is located at the same position as the widened portion in the longitudinal direction.

According to yet another aspect of the present disclosure, a heater includes an elongated substrate, the substrate having a first long side and a second long side when the heater is viewed in a direction perpendicular to a plane of the substrate, a first heat generation resistor disposed on the substrate along a longitudinal direction of the substrate, the first heat generation resistor being arranged at a position offset in a direction toward the first long side from a center of the substrate in a lateral direction of the substrate, a second heat generation resistor disposed on the substrate along the longitudinal direction, the second heat generation resistor being arranged at a position offset in a direction toward the second long side from the center in the lateral direction, a first electric contact in contact with a first terminal for power supply to the first heat generation resistor and power supply to the second heat generation resistor via the first heat generation resistor, the first electric contact being arranged at a position closer to one end of the substrate than the first heat generation resistor in the longitudinal direction, and the first electric contact being electrically connected to one end of the first heat generation resistor in the longitudinal direction, a second electric contact in contact with a second terminal for power supply to the second heat generation resistor and power supply to the first heat generation resistor via the second heat generation resistor, the second electric contact being arranged at a position closer to the one end of the substrate than the second heat generation resistor in the longitudinal direction, and the second electric contact being electrically connected to one end of the second heat generation resistor in the longitudinal direction, a first conductor disposed between the first heat generation resistor and the first electric contact in the longitudinal direction, the first conductor electrically connecting the first heat generation resistor and the first electric contact, a second conductor disposed between the second heat generation resistor and the second electric contact in the longitudinal direction, the second conductor electrically connecting the second heat generation resistor and the second electric contact, a third conductor electrically connecting another end of the first heat generation resistor opposite from the one end of the first heat generation resistor in the longitudinal direction and another end of the second heat generation resistor opposite from the one end of the second heat generation resistor in the longitudinal direction, and an insulating layer covering the first heat generation resistor, the second heat generation resistor, the first conductor, the second conductor, and the third conductor with the first electric contact and the second electric contact exposed, wherein the first heat generation resistor and the second heat generation resistor are electrically connected in series via the third conductor, the second electric contact is arranged at a position further away from the one end of the substrate than the first electric contact in the longitudinal direction, the position of the first electric contact and the position of the second electric contact overlap each other in the lateral direction, a first widened portion is provided in a region of the first conductor on a closer side to the one end of the substrate with respect to a first connection position of the first conductor with the first heat generation resistor, the first widened portion having a wider width in the lateral direction than a width of the first connection position in the lateral direction, a second widened portion is provided in a region of the second conductor on a closer side to the one end of the substrate with respect to a second connection position of the second conductor with the second heat generation resistor, the second widened portion having a wider width in the lateral direction than a width of the second connection position in the lateral direction, a first width constant portion is provided in all regions of the first conductor between the first widened portion and the first connection position in the longitudinal direction, the first width constant portion having a constant width in the lateral direction, a second width constant portion is provided in all regions of the second conductor between the second widened portion and the second connection position in the longitudinal direction, the second width constant portion having a constant width in the lateral direction, a side of the first width constant portion that faces the first long side of the substrate is linearly shaped in parallel with the first long side, a side of the second width constant portion that faces the second long side of the substrate is linearly shaped in parallel with the second long side, and a distance between the first connection position and the second connection position is longer than a distance between the first widened portion and the second widened portion in the lateral direction.

Features of the present disclosure will become apparent from the following description of embodiments with reference to the attached drawings. The following description of embodiments is described by way of example.

### BRIEF DESCRIPTION OF THE DRAWINGS

FIG. 1 illustrates an image forming apparatus.

FIG. 2 illustrates an image heating apparatus.

FIG. 3 illustrates the electric connection configuration of a heater according to a first embodiment.

FIGS. 4A to 4E each illustrate the shapes of conductors of the heater according to the first embodiment.

FIGS. 5A to 5D each illustrate the positional relationship between the heater and a pressing member according to the first embodiment.

FIG. 6 illustrates the electric connection configuration of a heater according to a second embodiment.

FIGS. 7A and 7B each illustrate the shapes of conductors of the heater according to the second embodiment.

FIGS. 8A and 8B illustrate the shapes of conductors of a heater according to another example of the first embodiment.

### DESCRIPTION OF THE EMBODIMENTS

In the following description, modes for carrying out the present disclosure will be exemplarily described in detail based on embodiments thereof with reference to the drawings. However, dimensions, materials, shapes, a relative layout, and the like of components that will be described in these embodiments shall be changed as appropriate according to the configuration of an apparatus to which the present disclosure is applied and various kinds of conditions. In other words, they are not intended to limit the scope of the present disclosure to the following embodiments.

### First Embodiment

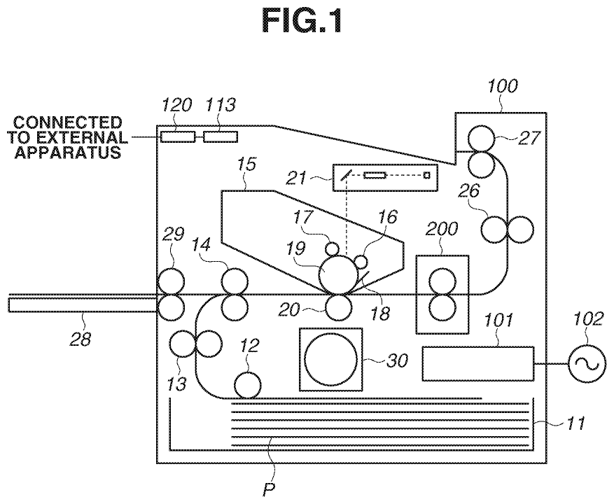

FIG. 1 is a schematic cross-sectional view of an image forming apparatus 100 using an electrophotographic recording technique. Examples of the image forming apparatus 100 include a copying machine and a printer using an electrophotographic method or an electrostatic recording method. The image forming apparatus 100 illustrated in FIG. 1 is a laser printer that forms an image on a recording material P using the electrophotographic method.

The image forming apparatus 100 includes a video controller 120 and a control unit 113. The video controller 120 functions to receive and process image information and a print instruction transmitted from an external apparatus such as a personal computer as an acquisition unit that acquires information about an image to be formed on the recording material P. The control unit 113 is connected to the video controller 120, and functions to control each unit constituting the image forming apparatus 100 according to an instruction from the video controller 120. When the video controller 120 receives the print instruction from the external apparatus, an image is formed by the following operation.

When the image forming apparatus 100 receives a print signal, a scanner unit 21 emits laser light modulated according to this image information and scans the surface of a photosensitive drum 19 charged to have predetermined polarity by a charging roller 16. Due to that, an electrostatic latent image is formed on the photosensitive drum 19. Toner is supplied from a development roller 17 to this electrostatic latent image, and the electrostatic latent image on the photosensitive drum 19 is developed as a toner image (a developer image) by that. On the other hand, a recording material (recording paper) P stacked in a sheet feeding cassette 11 is fed by a pickup roller 12 one by one, and is conveyed toward a registration roller pair 14 by a conveyance roller pair 13. Further, the recording material P is conveyed from the registration roller pair 14 to a transfer position in synchronization with a timing when the toner image on the photosensitive drum 19 reaches the transfer position defined by the photosensitive drum 19 and a transfer roller 20. The toner image on the photosensitive drum 19 is transferred onto the recording material P in the course of the recording material P passing through the transfer position. After that, the recording material P is heated by a fixing device (a fixing unit) 200 as an image heating apparatus (an image heating unit), and the toner image is heated and fixed onto the recording material P. The recording material P bearing the fixed toner image thereon is discharged onto a tray provided at the upper portion of the image forming apparatus 100 by conveyance roller pairs 26 and 27. A drum cleaner 18 removes the toner remaining on the photosensitive drum 19. A sheet feeding tray 28 (a manual feeding tray), which is a pair of recording material regulation plates having a width adjustable according to the size of the recording material P, is provided to support even the recording material P in a size that is not a standard size. A pickup roller 29 feeds the recording material P from the sheet feeding tray 28. The image forming apparatus 100 includes a motor 30, which drives the fixing device 200 and the like.

A control circuit 101 as a power control unit connected to a commercial alternating-current power source 102 supplies power to the fixing device 200. The photosensitive drum 19, the charging roller 16, the scanner unit 21, the development roller 17, and the transfer roller 20 described above constitute an image forming unit that forms an unfixed image on the recording material P. Further, in the present embodiment, a development unit including the photosensitive drum 19, the charging roller 16, and the development roller 17, and a cleaning unit including the drum cleaner 18 are configured detachably attachably to an apparatus main body of the image forming apparatus 100 as a process cartridge 15. Further, the fixing device 200 is also configured detachably attachably to the image forming apparatus 100.

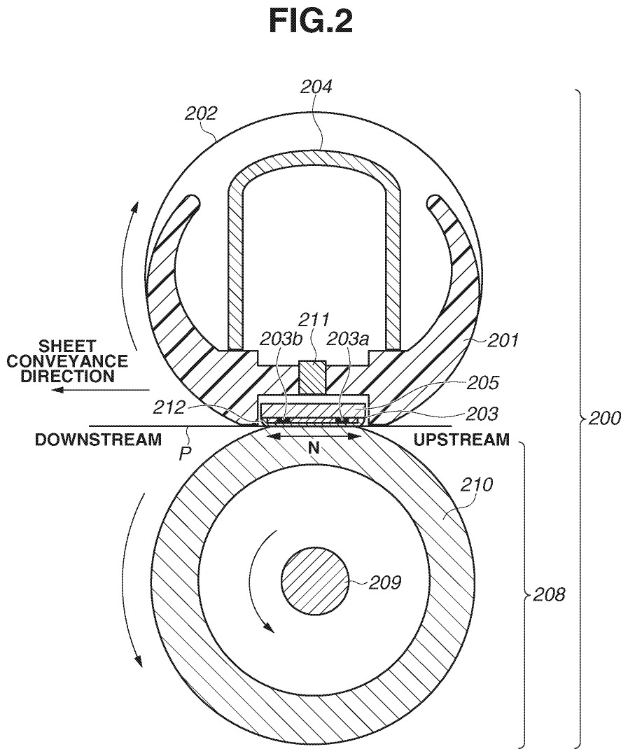

FIG. 2 is a cross-sectional view of the fixing device 200 according to the present embodiment. The fixing device 200 includes a fixing film (hereinafter referred to as a film) 202, and a heater 203 disposed in a space inside the film 202 in contact with the inner surface of the film 202. Further, the fixing device 200 includes a pressing roller (a pressing member) 208 that forms a fixing nip portion N together with the heater 203 via the film 202, and a metal stay 204. A metal plate may be disposed between the heater 203 and the film 202.

The film 202 is a tubularly formed heat-resistant film, which is also called an endless belt or an endless film, and the material of a base layer thereof is heat-resistant resin such as polyimide or metal such as stainless steel. Further, an elastic layer such as heat-resistant rubber may be provided on the surface of the film 202. The pressing roller 208 includes a metal core 209 made from a material such as iron or aluminum, and an elastic layer 210 made from a material such as silicone rubber. The heater 203 is held by a holding member 201 made from heat-resistant resin. The holding member 201 also has a guide function of guiding a rotation of the film 202. The metal stay 204 is provided to apply a pressure of a not-illustrated spring to the holding member 201.

The pressing roller 208 rotates in a direction indicated by an arrow by receiving motive power from the motor 30. Due to the rotation of the pressing roller 208, the film 202 rotates according thereto. The recording material P bearing the unfixed toner image thereon is subjected to fixing processing by being heated while being nipped and conveyed at the fixing nip portion N.

The heater 203 includes heat generation elements (heat generating resistors) 203a and 203b provided on an elongated ceramic substrate 205. An excessive temperature rise prevention device 211 is in abutment with the heater 203. A glass layer (an insulating layer) 212 is provided to ensure insulation between the heat generation elements 203a and 203b and the film 202. Examples of the excessive temperature rise prevention device 211 include a thermal switch or a thermal fuse, and the excessive temperature rise prevention device 211 is actuated and blocks power supplied to the heater 203 at the time of abnormal heat generation of the heater 203. The glass layer 212 is a layer provided to the heater 203.

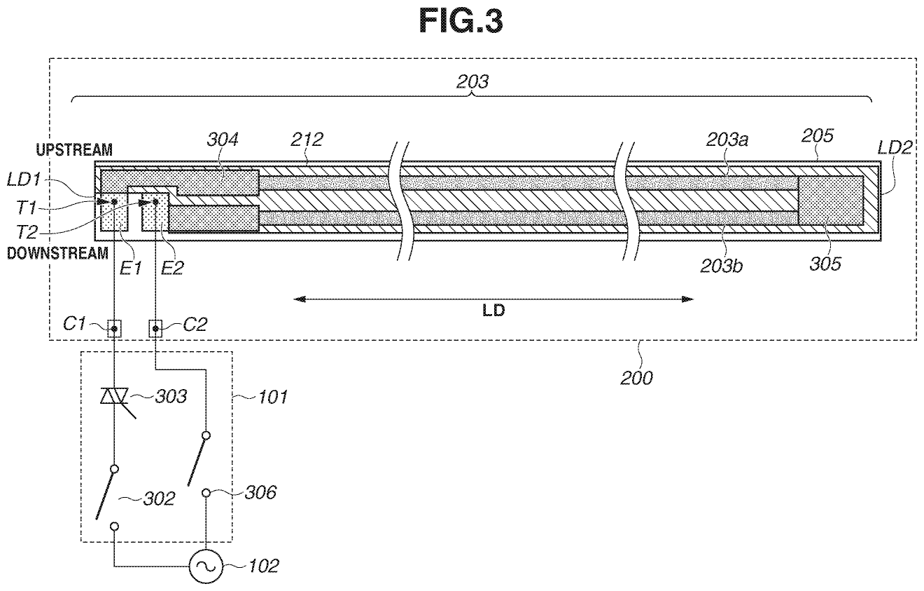

FIG. 3 is a schematic diagram illustrating the electric connection configuration of the heater 203 and the control circuit 101 according to the present embodiment. As illustrated in FIG. 3, one alternating-current terminal of the commercial alternating-current power source 102 is connected to a connection portion C1, which connects the fixing device 200 and the control circuit 101 via a relay 302 and a triac 303. The connection portion C1 is electrically connected to an electrode portion (an electric contact) E1 of the heater 203 via a terminal T1. The terminal T1 is in contact with the electrode portion E1. The other alternating-current terminal of the commercial alternating-current power source 102 is connected to an electrode portion (an electric contact) E2 of the heater 203 via a relay 306, a connection portion C2, and a terminal T2. The terminal T2 is in contact with the electrode portion E2. Therefore, the potential relationship between the electrode portion E1 and the electrode portion E2 is established as opposite polarities. The electrode portions E1 and E2 are disposed on one end LD1 side in a longitudinal direction LD of the substrate 205. The terminal T1 is a terminal for power supply to the heat generation element 203a and power supply to the heat generation element 203b via the heat generation element 203a. The terminal T2 is a terminal for power supply to the heat generation element 203b and power supply to the heat generation element 203a via the heat generation element 203b. The power supplied to the electrode portion E1 and the power supplied to the electrode portion E2 are connected to the heat generation element 203a and the heat generation element 203b via a conductor 304 on the heater 203, respectively. The heat generation element 203a and the heat generation element 203b are electrically connected via a conductor 305. A region illustrated as a hatched portion indicates the glass layer 212, and protects the region of the conductor 304, the heat generation elements 203a and 203b, and the conductor 305 described above so as to electrically insulate them from components other than the heater 203. An end LD2 is the opposite end of the substrate 205 in the longitudinal direction LD.

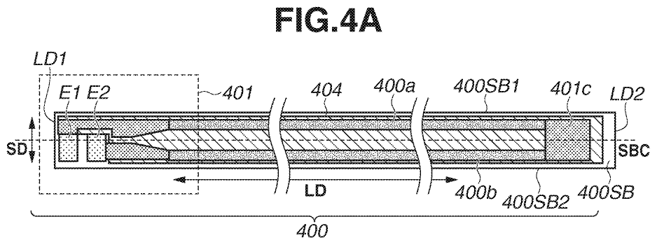

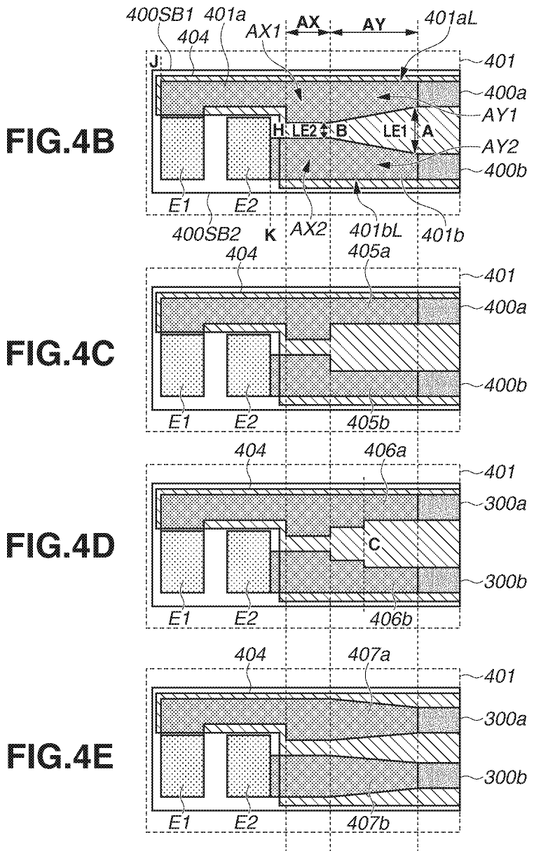

FIGS. 4A to 4D each illustrate a heater 400 including a conductor 401a, a conductor 401b, and the like according to the first embodiment. The heater 203 illustrated in FIGS. 2 and 3 is replaced with the heater 400, which is used while being connected to the control circuit 101 similarly to the heater 203. In the following description, a mechanism for suppressing a leakage current flowing between the conductor 401a and the conductor 401b via the glass layer 212 with the aid of the shapes of the conductor 401a, the conductor 401b, and the like will be described with reference to FIGS. 4A to 4D.

FIG. 4A is a plan view of the heater 400. The heater 400 includes a substrate 400SB. The substrate 400SB includes a first long side 400SB1 and a second long side 400SB2 when the heater 400 is viewed in a direction perpendicular to the plane of the substrate 400SB. A heat generation element 400a (a first heat generation resistor) and a heat generation element 400b (a second heat generation resistor) are disposed (printed) on the substrate 400SB. The heat generation element 400a is disposed along the longitudinal direction LD of the substrate 400SB. Further, the heat generation element 400a is arranged at a position offset in a direction toward the first long side 400SB1 from a center SBC of the substrate 400SB in a lateral direction SD of the substrate 400SB. The heat generation element 400b is disposed (printed) along the longitudinal direction LD of the substrate 400SB. Further, the heat generation element 400b is arranged at a position offset in a direction toward the second long side 400SB2 from the center SBC of the substrate 400SB in the lateral direction SD of the substrate 400SB. The electrode portion E1 (a first electric contact) is also disposed (printed) on the substrate 400SB. The terminal T1 for power supply to the heat generation element 400a and power supply to the heat generation element 400b via the heat generation element 400a is in contact with the electrode portion E1. The electrode portion E1 is arranged at a position closer to the one end LD1 of the substrate 400SB than the heat generation element 400a in the longitudinal direction LD, and is electrically connected to one end of the heat generation element 400a in the longitudinal direction LD. Further, the electrode portion E2 (a second electric contact) is also disposed (printed) on the substrate 400SB. The terminal T2 for power supply to the heat generation element 400b and power supply to the heat generation element 400a via the heat generation element 400b is in contact with the electrode portion E2. The electrode portion E2 is arranged at a position closer to the one end LD1 of the substrate 400SB than the heat generation element 400b in the longitudinal direction LD, and is electrically connected to one end of the heat generation element 400b in the longitudinal direction LD. Further, the conductor 401a (a first conductor) is disposed (printed) on the substrate 400SB. The conductor 401a is disposed between the heat generation element 400a and the electrode portion E1 in the longitudinal direction LD, and electrically connects the heat generation element 400a and the electrode portion E1. Further, the conductor 401b (a second conductor) is disposed (printed) on the substrate 400SB. The conductor 401b is disposed between the heat generation element 400b and the electrode portion E2 in the longitudinal direction LD, and electrically connects the heat generation element 400b and the electrode portion E2. Further, a conductor 401c (a third conductor) is disposed (printed) on the substrate 400SB. The conductor 401c electrically connects the other end of the heat generation element 400a opposite from the one end of the heat generation element 400a in the longitudinal direction LD and the other end of the heat generation element 400b opposite from the one end of the heat generation element 400b in the longitudinal direction LD. The heat generation element 400a and the heat generation element 400b are electrically connected in series via the conductor 401c. Further, a glass layer (the insulating layer) 404 is provided on the substrate 400SB. The glass layer 404 covers the heat generation element 400a, the heat generation resistor 400b, the conductor 401a, the conductor 401b, and the conductor 401c with the electrode portion E1 and the electrode portion E2 exposed. The glass layer 404 is indicated as a hatched region in FIG. 4A. The electrode portion E1, the electrode portion E2, the conductor 401a, and the conductor 401b may be made from the same material, or different materials may be used as the material of the electrode portion E1 and the electrode portion E2 and the material of the conductor 401a and the conductor 401b. Further, the electrode portion E1 and the electrode portion E2 may be formed to have a greater thickness than the thickness of the conductor 401a and the conductor 401b (for example, by being printed a larger number of times), thereby being further enhanced in strength. The glass layer 404 does not have to completely cover the conductor 401a and the conductor 401b. As illustrated in FIG. 4B, which will be described below, the glass layer 404 of the heater 400 does not cover the respective connection portions of the conductor 401a and the conductor 401b with the electrode portion E1 and the electrode portion E2. Conversely, the glass layer 404 may be disposed to cover a part of the electrode portion E1 and the electrode portion E2.

Further, the electrode portion E2 is arranged at a position different from the position of the electrode portion E1 in the longitudinal direction LD. In the case of the heater 400, the electrode E2 is arranged at a position further away from the one end LD1 of the substrate 400SB than the electrode E1 in the longitudinal direction LD. Further, the position of the electrode portion E1 and the position of the electrode portion E2 overlap each other in the lateral direction SD. FIG. 4B illustrates an enlarged view of a region 401 indicated by a dotted line in FIG. 4A. FIGS. 4C and 4D are modifications of FIG. 4B, and FIG. 4E is a reference example.

FIG. 4B illustrates one of examples of the shapes of the conductor 401a and the conductor 401b. In each of the conductor 401a and the conductor 401b illustrated in FIG. 4B, the width of the conductor on a broken line A is narrower than the width of the conductor on a broken line B, and the conductor width continuously increases from the broken line A to the broken line B. The broken line A indicates a connection position of the conductor 401a with the heat generation element 400a (a first connection position), and a connection position of the conductor 401b with the heat generation element 400b (a second connection position). The broken line B indicates the boundary between a region AX and a region AY, which will be described below. A broken line H indicates the end portions of regions AX1 and AX2 in the longitudinal direction LD. A broken line J indicates the end portion of the conductor 401a in the longitudinal direction LD. A broken line K indicates the end portion of the conductor 401b in the longitudinal direction LD.

The widened portion AX1 (a first widened portion) of the conductor 401a is provided in the region AX of the conductor 401a on a closer side to the one end LD1 of the substrate 400SB with respect to the first connection position of the conductor 401a with the heat generation element 400a. The widened portion AX1 of the conductor 401a is a portion wider in width in the lateral direction SD than the width of the first connection position in the lateral direction SD. Further, the widened portion AX2 (a second widened portion) of the conductor 401b is provided in the region AX of the conductor 401b on a closer side to the one end LD1 of the substrate 400SB with respect to the second connection position of the conductor 401b with the heat generation element 400b. The widened portion AX2 of the conductor 401b is a portion wider in width in the lateral direction SD than the width of the second connection position in the lateral direction SD.

A first width change portion AY1 is provided in the region AY of the conductor 401a between the widened portion AX1 and the first connection position of the conductor 401a in the longitudinal direction LD. The width of the first width change portion AY1 in the lateral direction SD reduces from the widened portion AX1 toward the first connection position. A second width change portion AY2 is provided in the region AY of the conductor 401b between the widened portion AX2 and the second connection position of the conductor 401b in the longitudinal direction LD. The width of the second width change portion AY2 in the lateral direction SD reduces from the widened portion AX2 toward the second connection position.

A side 401aL of the first width change portion AY1, which faces the first long side 400SB1 of the substrate 400SB, is linearly shaped in parallel with the first long side 400SB1. A side 401bL of the second width change portion AY2, which faces the second long side 400SB2 of the substrate 400SB, is linearly shaped in parallel with the second long side 400SB2. Due to such shapes, the heat generation element 400a and the heat generation element 400b can be disposed close to the first long side 400SB1 and the second long side 400SB2 of the substrate 400SB, respectively. This can contribute to reducing thermal stress applied to the substrate 400SB when the heat generation element 400a and the heat generation element 400b generate heat. Especially, when the material of the substrate 400SB is ceramic, such a shape is effective. In the case of the example illustrated in FIG. 4B, the side of the conductor 401a that faces the first long side 400SB1 is entirely (from the broken line A to the broken line J) linearly shaped in parallel with the first long side 400SB1, and the side of the conductor 401b that faces the second long side 400SB2 is entirely (from the broken line A to the broken line K) linearly shaped in parallel with the second long side 400SB2.

A distance LE1 between the first connection position and the second connection position is longer than a distance LE2 between the widened portion AX1 and the widened portion AX2 in the lateral direction SD. The distance between the first conductor 401a and the conductor 401b in the lateral direction SD gradually increases from the first widened portion AX1 toward the first connection position.

When the temperatures of the heat generation element 400a and the heat generation element 400b increase, the temperature of the glass layer 404 located near the heat generation elements 400a and 400b also increases. Glass tends to reduce in electric resistance thereof according to an increase in temperature. On the other hand, the temperature of the glass increases less on the broken line B compared with the temperature near the broken line A because of the presence of a certain distance from the heat generation elements 400a and 400b.

In other words, the glass on the broken line B is expected to have high electric resistance compared with the electric resistance on the broken line A. In light thereof, on the broken line A, the present embodiment reduces the conductor widths of the conductor 401a and the conductor 401b to thus increase the distance between the conductors in the lateral direction SD of the substrate, thereby increasing the electric resistance of the glass between the conductors to suppress a leakage current. On the other hand, because a leakage current derived from a temperature increase is less likely generated on the broken line B, the present embodiment increases the conductor widths, thereby reducing the electric resistance between the conductor 401a and the conductor 402b.

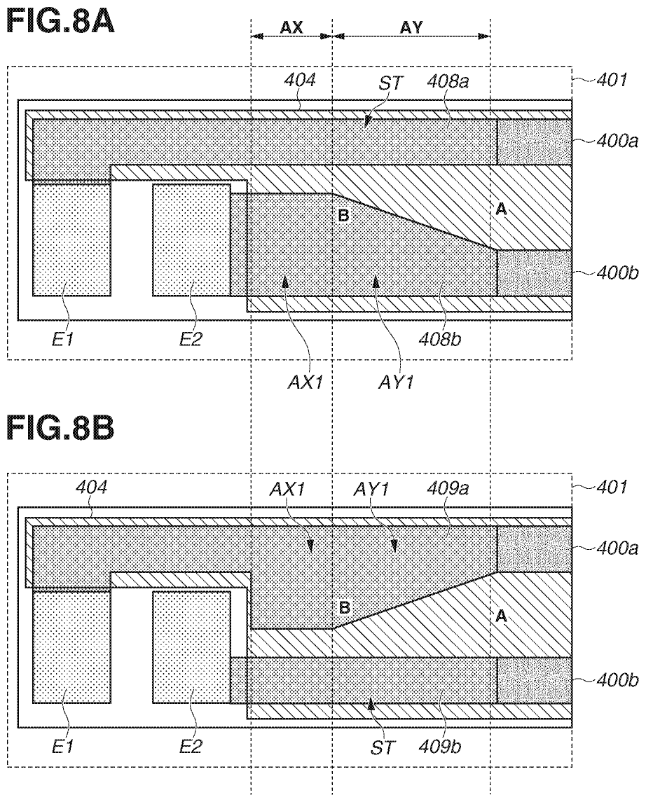

Then, the heater 400 may be configured in such a manner that the widened portion AX1 and the width change portion AY1 are provided to only one of the two conductors as illustrated in FIGS. 8A and 8B. In FIG. 8A, a conductor 408b includes the widened portion AX1 and the width change portion AY1, and a conductor 408a includes a width constant portion ST kept constant in width in the lateral direction SD. Conversely, in FIG. 8B, the conductor 408a includes the widened portion AX1 and the width change portion AY1, and the conductor 408b includes the width constant portion ST kept constant in width in the lateral direction SD.

FIG. 4C illustrates another example of the conductor shapes. A conductor 405a and a conductor 405b illustrated in FIG. 4C have a wider width between the conductors on the broken line A than the width between the conductors on the broken line B similarly to the example illustrated in FIG. 4B. The conductor widths of the conductor 405a and the conductor 405b are kept constant in all regions between the broken line A and the broken line B (a first width constant portion and a second width constant portion).

FIG. 4D illustrates another example of the conductor shapes. A conductor 406a and a conductor 406b illustrated in FIG. 4D also have a wider width between the conductors on the broken line A than the width between the conductors on the broken line B similarly to the examples illustrated in FIGS. 4B and 4C. Further, the conductor widths of the conductor 406a and the conductor 406b are changed at a position of a broken line C located between the broken lines A and B. The change point of the conductor width between the broken lines A and B is located only at one position on the broken line C in the example illustrated in FIG. 4D, but may be provided at a plurality of positions. In the example illustrated in FIG. 4D, the distance between the conductor 406a and the conductor 406b in the lateral direction SD increases from the widened portion corresponding to the region AX toward the connection position in a stepwise manner.

FIG. 4E illustrates a reference example of the conductor shapes. A conductor 407a and a conductor 407b illustrated in FIG. 4E also have a wider width between the conductors on the broken line A than the width between the conductors on the broken line B similarly to the examples illustrated in FIGS. 4B, 4C, and 4D. The conductor width may be changed in a stepwise manner starting from the broken line B illustrated in FIG. 4E on the two sides of the conductor illustrated in FIG. 4E, although this is not illustrated here.

In this manner, shaping the conductors as illustrated in FIGS. 4B to 4D can achieve a reduction in the resistance value of the conductor while suppressing a leakage current between opposite electrodes near the heat generation element. Further, thermal stress applied to the substrate 400SB can be reduced.

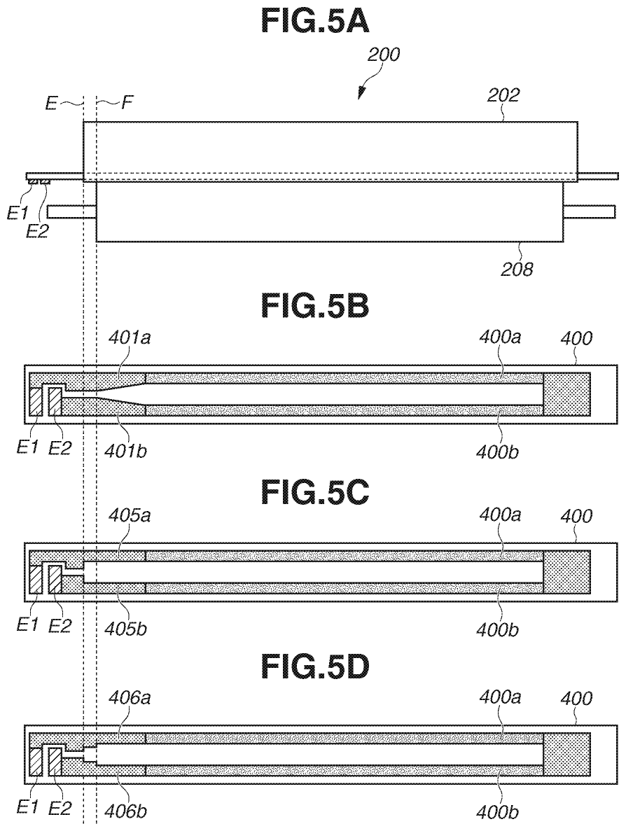

FIGS. 5A to 5D illustrate the fixing device 200 illustrated in FIG. 2 and the heater 400 having the conductor shapes illustrated in FIGS. 4A to 4E. In the following description, the positional relationship between the change point of the conductor width and the inside of the fixing device 200 will be described with reference to FIGS. 5A to 5D.

A broken line E illustrated in FIG. 5A indicates the position of the end portion of the film 202, and a broken line F indicates the position of the end portion of the pressing roller 208. The film 202 shifts to one side in the longitudinal direction LD while rotating due to, for example, tolerances of components, the pose of the recording material P during the fixing processing, and the position in the fixing nip portion N in the longitudinal direction LD where the recording material P passes through. The position of the broken line E illustrated in FIG. 5A is a position when the film 202 maximumly shifts leftward in FIG. 5A.

FIG. 5B illustrates the heater 400 including the conductor 401a and the conductor 401b illustrated in FIG. 4B, and the broken line B in FIG. 4B corresponds to the position of the broken line F in FIGS. 5A to 5D. The example illustrated in FIG. 5B suppresses a leakage current by changing the conductor width from the heat generation element 400a and the heat generation element 400b to the broken line F in consideration of a temperature increase in the pressing roller 208. The broken line B in FIGS. 4A to 4E and the broken line F in FIG. 5 are aligned in FIGS. 5A to 5D, but the broken line B may be located on the electrode side with respect to the broken line F. In other words, the one end F of the pressing roller 208 in the longitudinal direction LD may be located on the boundary between the first widened portion AX1 and the first width change portion AY1 or in the region of the first width change portion AY1. The temperature increases in a region nipped by the pressing roller 208 together with the heater 400 via the film 202 (the fixing nip portion N), and therefore it is more desirable that a long distance is present between the conductors in this region where the temperature is expected to increase.

FIG. 5C illustrates the heater 400 including the conductor 405a and the conductor 405b illustrated in FIG. 4C, and the broken line B in FIGS. 4A to 4E corresponds to the position of the broken line E in FIGS. 5A to 5D. The example illustrated in FIG. 5C reduces the conductor width from the heat generation element 400a and the heat generation element 400b to the broken line E (i.e., increases the distance between the conductors) in consideration of a temperature increase in the film 202 due to thermal conduction of the film 202. The broken line B in FIGS. 4A to 4E and the broken line E in FIGS. 5A to 5D are aligned in FIGS. 5A to 5D, but the broken line B may be located on the electrode side with respect to the broken line E.

FIG. 5D illustrates the heater 400 including the conductor 406a and the conductor 406b illustrated in FIG. 4D, and the broken line B in FIGS. 4A to 4E and the broken line C in FIG. 4D correspond to the position of the broken line E in FIGS. 5A to 5D and the position of the broken line F in FIGS. 5A to 5D, respectively. The example illustrated in FIG. 5D changes the conductor widths of the conductor 406a and the conductor 406b according to the position of the end portion of each member in consideration of temperature increases in the film 202 and the pressing roller 208. The position of the broken line C illustrated in FIG. 4D may be located on the electrode side (a position closer to the broken line B) in FIG. 5D.

In this manner, the present embodiment changes the conductor width according to the positions of the members inside the fixing device 200, thereby achieving a reduction in the resistance value of the conductor while suppressing a leakage current between opposite electrodes.

### Second Embodiment

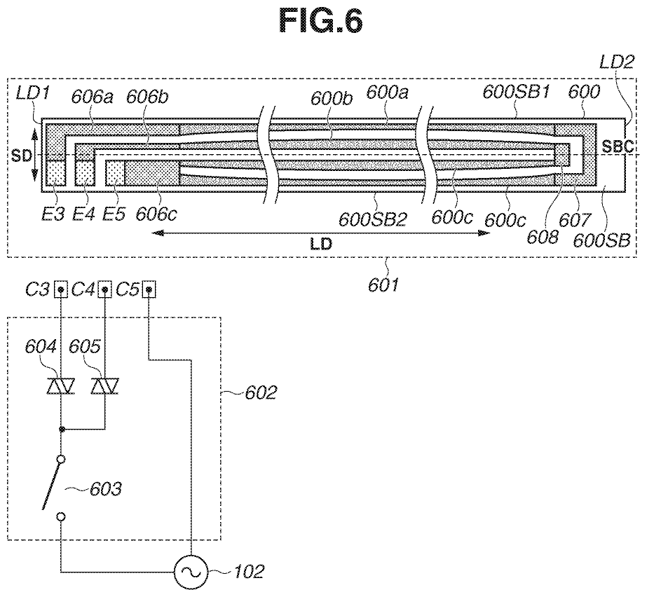

A heater 600 according to a second embodiment will be described with reference to FIG. 6, and 7A and 7B. FIG. 6 illustrates the electric connection configuration of a fixing device 601 and a control circuit 602 according to the present embodiment. FIG. 6 illustrates a heater plan view of the heater 600. Assume that portions that will not be especially described in the present embodiment are similar to the first embodiment.

As illustrated in FIG. 6, one alternating-current terminal of the commercial alternating-current power source 102 is connected to each of triacs 604 and 605 via a relay 603. Beyond that, the commercial alternating-current power source 102 is connected to connection portions C3 and C4, which connect the fixing device 601 and the control circuit 602. The connection portions C3 and C4 are electrically connected to electrode portions E3 (a third electric contact) and E4 (the first electric contact) of the heater 600, respectively, via terminals (not illustrated) similar to the terminal T1 and the terminal T2 illustrated in FIG. 3 in the fixing device 601. The other alternating-current terminal of the commercial alternating-current power source 102 is connected to an electrode portion E5 (the second electric contact) of the heater 600 in the fixing device 601 via a not-illustrated terminal in contact with the electrode E5, via a connection portion C5. Therefore, the potential relationship between E3/E4 and E5 is established as opposite polarities. Power supplied to E3 and power supplied to E4 are connected to a heat generation element 600a (a third heat generation resistor) and a heat generation element 600b (the first heat generation resistor) via a conductor 606a (a fourth conductor) and a conductor 606b (the first conductor) on the heater 600, respectively. Power supplied to E5 is connected to a heat generation element 600c (the second heat generation resistor) and a heat generation element 600d (a fourth heat generation resistor) via a conductor 606c (the second conductor). The heat generation element 600a and the heat generation element 600d are electrically connected via a conductor 607 (a fifth conductor). The heat generation element 600b and the heat generation element 600c are electrically connected via a conductor 608 (the third conductor). The heater 600 includes a glass layer and is configured to be electrically insulated from components other than the heater 600 similarly to FIG. 3, but this will be omitted here. The heat generation elements 600a to 600d have tapered shapes for the purpose of suppressing a temperature increase at the end portions of the heater 600 where the recording material P does not pass through at the time of printing on small-sized paper. The heat generation element 600a and the heat generation element 600d each have a heat generation element width wide at the end portions and narrow at the center in the longitudinal direction LD. The heat generation element 600b and the heat generation element 600c each have a heat generation element width narrow at the end portions and wide at the center in the longitudinal direction LD. The heat generation distribution of the heater 600 in the longitudinal direction LD is controlled by controlling the heat generation ratio between a group of the heat generation element 600a and the heat generation element 600d and a group of the heat generation element 600b and the heat generation element 600c using the triacs 604 and 605.

In this manner, the heater 600 has the following configuration in addition to the heater 400 described in the first embodiment. That is, the heat generation element 600a (the third heat generation resistor) is disposed on the substrate 600SB along the longitudinal direction LD. The heat generation element 600a is arranged at a position more offset in a direction toward a first long side 600SB1 from the center SBC in the lateral direction SD than the heat generation element 600b (the first heat generation resistor). The heat generation element 600d (the fourth heat generation resistor) is disposed on the substrate 600SB along the longitudinal direction LD. The heat generation element 600d is arranged at a position more offset in a direction toward a second long side 600SB2 from the center SBC in the lateral direction SD than the heat generation element 600c (the second heat generation resistor).

Further, the electrode E3 (the third electric contact) is disposed on the substrate 600. The third terminal for power supply to the heat generation element 600a (the third heat generation resistor) and power supply to the heat generation element 600d (the fourth heat generation resistor) via the heat generation element 600a is in contact with the electrode E3. The electrode E3 is arranged at a position closer to the one end LD of the substrate 600 than the heat generation element 600a in the longitudinal direction LD, and is electrically connected to one end of the heat generation element 600a in the longitudinal direction LD. Further, the conductor 606a (the fourth conductor) is disposed on the substrate 600. The conductor 606a is disposed between the heat generation element 600a and the electrode E3 in the longitudinal direction LD, and electrically connects the heat generation element 600a and the electrode E3. Further, the conductor 607 (the fifth conductor) is disposed on the substrate 600. The conductor 607 electrically connects the other end of the heat generation element 600a opposite from the one end of the heat generation element 600a in the longitudinal direction LD and the other end of the heat generation element 600d opposite from the one end of the heat generation element 600d in the longitudinal direction LD.

The heat generation element 600d (the fourth heat generation resistor) is electrically connected to the electrode E5 (the second electric contact) via the conductor 606c (the second conductor). The heat generation element 600a and the heat generation element 600d are electrically connected in series via the conductor 607 (the fifth conductor). The electrode E3 is arranged at a position closer to the one end LD1 of the substrate 600SB than the electrode E4 (the first electric contact) in the longitudinal direction LD. The position of the electrode E3 overlaps the position of the electrode E4 and the position of the electrode E5 in the lateral direction SD.

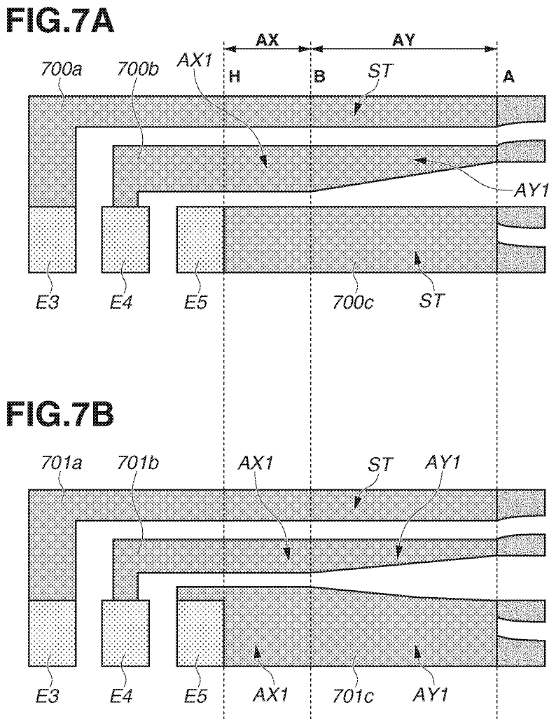

FIGS. 7A and 7B illustrate conductors 700a to 700c and the like of the heater 600 according to the second embodiment. The substrate and the glass layer are omitted in FIGS. 7A and 7B. Further, the conductor 606a, the conductor 606b, and the conductor 606c illustrated in FIG. 6 are replaced with the conductor 700a, the conductor 700b, and the conductor 700c, or a conductor 701a, a conductor 701b, and a conductor 701c. A mechanism for suppressing a leakage current flowing between the conductor 700b and the conductor 700c using them will be described.

FIG. 7A illustrates one of examples of the conductor shapes 700a to 700c according to the second embodiment. Regarding the conductor 700b (the first conductor) illustrated in FIG. 7A, the width of the conductor 700b on the broken line A is narrower than the width of the conductor 700b on the broken line B. Further, the conductor width gradually increases from the broken line A to the broken line B. Because the conductor 700a and the conductor 700b are the same in polarity and no leakage current is generated therebetween, the distance between the conductor 700a and the conductor 700b is kept constant. In FIG. 7A, the conductor 700b includes the widened portion AX1 in the region AX and the width change portion AY1 in the region AY. The conductor 700c includes the width constant portion ST, which is kept constant in width in the lateral direction SD, in the region AY. The conductor 700a (the fourth conductor) also includes the width constant portion ST in the region AY.

FIG. 7B illustrates another example of the conductor shapes. Regarding the conductor 701b and the conductor 701c illustrated in FIG. 7B, the width of the conductor on the broken line A is narrower than the width of the conductor on the broken line B. Further, the conductor width gradually increases from the broken line A to the broken line B. In FIG. 7B, the conductor 701c has a wider conductor width compared with FIG. 7A, thereby reducing in electric resistance thereof. In FIG. 7B, the conductor 701b includes the widened portion AX1 in the region AX and the width change portion AY1 in the region AY. The conductor 701c includes the widened portion AX1 in the region AX and the width change portion AY1 in the region AY. The conductor 701a (the fourth conductor) includes the width constant portion ST in the region AY.

In this manner, shaping the conductors as illustrated in FIGS. 7A and 7B can achieve a reduction in the resistance value of the conductor while suppressing a leakage current between opposite polarities near the heat generation element.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Applications No. 2025-074593, filed Apr. 28, 2025, and No. 2026-025638, filed Feb. 19, 2026, which are hereby incorporated by reference herein in their entirety.

1. A heater comprising:
an elongated substrate, the substrate having a first long side and a second long side when the heater is viewed in a direction perpendicular to a plane of the substrate;
a first heat generation resistor disposed on the substrate along a longitudinal direction of the substrate, the first heat generation resistor being arranged at a position offset in a direction toward the first long side from a center of the substrate in a lateral direction of the substrate;
a second heat generation resistor disposed on the substrate along the longitudinal direction, the second heat generation resistor being arranged at a position offset in a direction toward the second long side from the center in the lateral direction;
a first electric contact in contact with a first terminal for power supply to the first heat generation resistor and power supply to the second heat generation resistor via the first heat generation resistor, the first electric contact being arranged at a position closer to one end of the substrate than the first heat generation resistor in the longitudinal direction, and the first electric contact being electrically connected to one end of the first heat generation resistor in the longitudinal direction;
a second electric contact in contact with a second terminal for power supply to the second heat generation resistor and power supply to the first heat generation resistor via the second heat generation resistor, the second electric contact being arranged at a position closer to the one end of the substrate than the second heat generation resistor in the longitudinal direction, and the second electric contact being electrically connected to one end of the second heat generation resistor in the longitudinal direction;
a first conductor disposed between the first heat generation resistor and the first electric contact in the longitudinal direction, the first conductor electrically connecting the first heat generation resistor and the first electric contact;
a second conductor disposed between the second heat generation resistor and the second electric contact in the longitudinal direction, the second conductor electrically connecting the second heat generation resistor and the second electric contact;
a third conductor electrically connecting another end of the first heat generation resistor opposite from the one end of the first heat generation resistor in the longitudinal direction and another end of the second heat generation resistor opposite from the one end of the second heat generation resistor in the longitudinal direction; and
an insulating layer covering the first heat generation resistor, the second heat generation resistor, the first conductor, the second conductor, and the third conductor with the first electric contact and the second electric contact exposed,
wherein the first heat generation resistor and the second heat generation resistor are electrically connected in series via the third conductor,
the second electric contact is arranged at a position further away from the one end of the substrate than the first electric contact in the longitudinal direction,
the position of the first electric contact and the position of the second electric contact overlap each other in the lateral direction,
a first widened portion is provided in a region of the first conductor on a closer side to the one end of the substrate with respect to a first connection position of the first conductor with the first heat generation resistor, the first widened portion having a wider width in the lateral direction than a width of the first connection position in the lateral direction,
a second widened portion is provided in a region of the second conductor on a closer side to the one end of the substrate with respect to a second connection position of the second conductor with the second heat generation resistor, the second widened portion having a wider width in the lateral direction than a width of the second connection position in the lateral direction,
a first width change portion is provided in a region of the first conductor between the first widened portion and the first connection position in the longitudinal direction, the first width change portion having a width in the lateral direction that reduces from the first widened portion toward the first connection position,
a second width change portion is provided in a region of the second conductor between the second widened portion and the second connection position in the longitudinal direction, the second width change portion having a width in the lateral direction that reduces from the second widened portion toward the second connection position,
a side of the first width change portion that faces the first long side of the substrate is linearly shaped in parallel with the first long side,
a side of the second width change portion that faces the second long side of the substrate is linearly shaped in parallel with the second long side, and
a distance between the first connection position and the second connection position is longer than a distance between the first widened portion and the second widened portion in the lateral direction.

2. The heater according to claim 1, wherein a distance between the first conductor and the second conductor in the lateral direction gradually increases from the first widened portion toward the first connection position.

3. The heater according to claim 1, wherein a distance between the first conductor and the second conductor in the lateral direction increases from the first widened portion toward the first connection position in a stepwise manner.

4. The heater according to claim 1, wherein a side of the first conductor that faces the first long side is entirely linearly shaped in parallel with the first long side, and a side of the second conductor that faces the second long side is entirely linearly shaped in parallel with the second long side.

5. The heater according to claim 1, wherein the insulating layer is a glass layer.

6. The heater according to claim 1, further comprising:
a third heat generation resistor disposed on the substrate along the longitudinal direction, the third heat generation resistor being arranged at a position more offset in the direction toward the first long side from the center in the lateral direction than the first heat generation resistor;
a fourth heat generation resistor disposed on the substrate along the longitudinal direction, the fourth heat generation resistor being arranged at a position more offset in the direction toward the second long side from the center in the lateral direction than the second heat generation resistor;
a third electric contact in contact with a third terminal for power supply to the third heat generation resistor and power supply to the fourth heat generation resistor via the third heat generation resistor, the third electric contact being arranged at a position closer to the one end of the substrate than the third heat generation resistor in the longitudinal direction, and the third electric contact being electrically connected to one end of the third heat generation resistor in the longitudinal direction;
a fourth conductor disposed between the third heat generation resistor and the third electric contact in the longitudinal direction, the fourth conductor electrically connecting the third heat generation resistor and the third electric contact; and
a fifth conductor electrically connecting another end of the third heat generation resistor opposite from the one end of the third heat generation resistor in the longitudinal direction and another end of the fourth heat generation resistor opposite from one end of the fourth heat generation resistor in the longitudinal direction,
wherein the fourth heat generation resistor is electrically connected to the second electric contact via the second conductor,
the third heat generation resistor and the fourth heat generation resistor are electrically connected in series via the fifth conductor,
the third electric contact is arranged at a position closer to the one end of the substrate than the first electric contact in the longitudinal direction, and
the position of the third electric contact overlaps the position of the first electric contact and the position of the second electric in the lateral direction.

7. The heater according to claim 6, wherein a region of the fourth conductor that is located at the same position as the first width change portion of the first conductor in the longitudinal direction is constant in width in the lateral direction.

8. An image heating apparatus configured to heat an image formed on a recording material, the image heating apparatus comprising:
a tubular film configured to rotate in contact with the recording material;
the heater according to claim 1, the heater being disposed in a space inside the film;
a roller forming a nip portion configured to nip the recording material together with the heater via the film;
the first terminal; and
the second terminal.

9. The image heating apparatus according to claim 8,
wherein one end of the roller is located at a boundary between the first widened portion and the first width change portion or in a region of the first width change portion in the longitudinal direction.

10. An image heating apparatus configured to heat an image formed on a recording material, the image heating apparatus comprising:
a tubular film configured to rotate in contact with the recording material;
the heater according to claim 6, the heater being disposed in a space inside the film;
a roller forming a nip portion configured to nip the recording material together with the heater via the film;
the first terminal;
the second terminal; and
the third terminal.

11. The image heating apparatus according to claim 10, wherein one end of the roller is located at a boundary between the first widened portion and the first width change portion or in a region of the first width change portion in the longitudinal direction.

12. A heater comprising:
an elongated substrate, the substrate having a first long side and a second long side when the heater is viewed in a direction perpendicular to a plane of the substrate;
a first heat generation resistor disposed on the substrate along a longitudinal direction of the substrate, the first heat generation resistor being arranged at a position offset in a direction toward the first long side from a center of the substrate in a lateral direction of the substrate;
a second heat generation resistor disposed on the substrate along the longitudinal direction, the second heat generation resistor being arranged at a position offset in a direction toward the second long side from the center in the lateral direction;
a first electric contact in contact with a first terminal for power supply to the first heat generation resistor and power supply to the second heat generation resistor via the first heat generation resistor, the first electric contact being arranged at a position closer to one end of the substrate than the first heat generation resistor in the longitudinal direction, and the first electric contact being electrically connected to one end of the first heat generation resistor in the longitudinal direction;
a second electric contact in contact with a second terminal for power supply to the second heat generation resistor and power supply to the first heat generation resistor via the second heat generation resistor, the second electric contact being arranged at a position closer to the one end of the substrate than the second heat generation resistor in the longitudinal direction, and the second electric contact being electrically connected to one end of the second heat generation resistor in the longitudinal direction;
a first conductor disposed between the first heat generation resistor and the first electric contact in the longitudinal direction, the first conductor electrically connecting the first heat generation resistor and the first electric contact;
a second conductor disposed between the second heat generation resistor and the second electric contact in the longitudinal direction, the second conductor electrically connecting the second heat generation resistor and the second electric contact;
a third conductor electrically connecting another end of the first heat generation resistor opposite from the one end of the first heat generation resistor in the longitudinal direction and another end of the second heat generation resistor opposite from the one end of the second heat generation resistor in the longitudinal direction; and
an insulating layer covering the first heat generation resistor, the second heat generation resistor, the first conductor, the second conductor, and the third conductor with the first electric contact and the second electric contact exposed,
wherein the first heat generation resistor and the second heat generation resistor are electrically connected in series via the third conductor,
the second electric contact is arranged at a position different from a position of the first electric contact in the longitudinal direction,
the position of the first electric contact and the position of the second electric contact overlap each other in the lateral direction,
a widened portion is provided in a region of the first conductor on a closer side to the one end of the substrate with respect to a connection position of the first conductor with the first heat generation resistor, the widened portion having a wider width in the lateral direction than a width of the connection position in the lateral direction,
a width change portion is provided in a region of the first conductor between the widened portion and the connection position in the longitudinal direction, the width change portion having a width in the lateral direction that reduces from the widened portion toward the connection position,
a side of the width change portion that faces the first long side of the substrate is linearly shaped in parallel with the first long side,
a side of the second conductor facing the second long side of the substrate and located in the same region as the width change portion in the longitudinal direction is linearly shaped in parallel with the second long side, and
a distance between the connection position of the first conductor with the first heat generation resistor and a connection position of the second conductor with the second heat generation resistor in the lateral direction is longer than a distance between the widened portion and a region of the second conductor that is located at the same position as the widened portion in the longitudinal direction.

13. The heater according to claim 12, wherein a side of the first conductor that faces the first long side is entirely linearly shaped in parallel with the first long side, and a side of the second conductor that faces the second long side is entirely linearly shaped in parallel with the second long side.

14. The heater according to claim 12, wherein the second electric contact is arranged at a position further away from the one end of the substrate than the first electric contact in the longitudinal direction.

15. The heater according to claim 12, wherein the first electric contact is arranged at a position further away from the one end of the substrate than the second electric contact in the longitudinal direction.

16. The heater according to claim 12, wherein the insulating layer is a glass layer.

17. The heater according to claim 12, further comprising:
a third heat generation resistor disposed on the substrate along the longitudinal direction, the third heat generation resistor being arranged at a position more offset in the direction toward the first long side from the center in the lateral direction than the first heat generation resistor;
a fourth heat generation resistor disposed on the substrate along the longitudinal direction, the fourth heat generation resistor being arranged at a position more offset in the direction toward the second long side from the center in the lateral direction than the second heat generation resistor;
a third electric contact in contact with a third terminal for power supply to the third heat generation resistor and power supply to the fourth heat generation resistor via the third heat generation resistor, the third electric contact being arranged at a position closer to the one end of the substrate than the third heat generation resistor in the longitudinal direction, and the third electric contact being electrically connected to one end of the third heat generation resistor in the longitudinal direction;
a fourth conductor disposed between the third heat generation resistor and the third electric contact in the longitudinal direction, the fourth conductor electrically connecting the third heat generation resistor and the third electric contact; and
a fifth conductor electrically connecting another end of the third heat generation resistor opposite from the one end of the third heat generation resistor in the longitudinal direction and another end of the fourth heat generation resistor opposite from one end of the fourth heat generation resistor in the longitudinal direction,
wherein the fourth heat generation resistor is electrically connected to the second electric contact via the second conductor,
the third heat generation resistor and the fourth heat generation resistor are electrically connected in series via the fifth conductor,
the third electric contact is arranged at a position different from the position of the first electric contact and the position of the second electric contact in the longitudinal direction, and
the position of the third electric contact overlaps the position of the first electric contact and the position of the second electric contact in the lateral direction.

18. The heater according to claim 17, wherein a region of the fourth conductor that is located at the same position as the width change portion of the first conductor in the longitudinal direction is constant in width in the lateral direction.

19. A heater comprising:
an elongated substrate, the substrate having a first long side and a second long side when the heater is viewed in a direction perpendicular to a plane of the substrate;
a first heat generation resistor disposed on the substrate along a longitudinal direction of the substrate, the first heat generation resistor being arranged at a position offset in a direction toward the first long side from a center of the substrate in a lateral direction of the substrate;
a second heat generation resistor disposed on the substrate along the longitudinal direction, the second heat generation resistor being arranged at a position offset in a direction toward the second long side from the center in the lateral direction;
a first electric contact in contact with a first terminal for power supply to the first heat generation resistor and power supply to the second heat generation resistor via the first heat generation resistor, the first electric contact being arranged at a position closer to one end of the substrate than the first heat generation resistor in the longitudinal direction, and the first electric contact being electrically connected to one end of the first heat generation resistor in the longitudinal direction;
a second electric contact in contact with a second terminal for power supply to the second heat generation resistor and power supply to the first heat generation resistor via the second heat generation resistor, the second electric contact being arranged at a position closer to the one end of the substrate than the second heat generation resistor in the longitudinal direction, and the second electric contact being electrically connected to one end of the second heat generation resistor in the longitudinal direction;
a first conductor disposed between the first heat generation resistor and the first electric contact in the longitudinal direction, the first conductor electrically connecting the first heat generation resistor and the first electric contact;
a second conductor disposed between the second heat generation resistor and the second electric contact in the longitudinal direction, the second conductor electrically connecting the second heat generation resistor and the second electric contact;
a third conductor electrically connecting another end of the first heat generation resistor opposite from the one end of the first heat generation resistor in the longitudinal direction and another end of the second heat generation resistor opposite from the one end of the second heat generation resistor in the longitudinal direction; and
an insulating layer covering the first heat generation resistor, the second heat generation resistor, the first conductor, the second conductor, and the third conductor with the first electric contact and the second electric contact exposed,
wherein the first heat generation resistor and the second heat generation resistor are electrically connected in series via the third conductor,
the second electric contact is arranged at a position further away from the one end of the substrate than the first electric contact in the longitudinal direction,
the position of the first electric contact and the position of the second electric contact overlap each other in the lateral direction,
a first widened portion is provided in a region of the first conductor on a closer side to the one end of the substrate with respect to a first connection position of the first conductor with the first heat generation resistor, the first widened portion having a wider width in the lateral direction than a width of the first connection position in the lateral direction,
a second widened portion is provided in a region of the second conductor on a closer side to the one end of the substrate with respect to a second connection position of the second conductor with the second heat generation resistor, the second widened portion having a wider width in the lateral direction than a width of the second connection position in the lateral direction,
a first width constant portion is provided in all regions of the first conductor between the first widened portion and the first connection position in the longitudinal direction, the first width constant portion having a constant width in the lateral direction,
a second width constant portion is provided in all regions of the second conductor between the second widened portion and the second connection position in the longitudinal direction, the second width constant portion having a constant width in the lateral direction,
a side of the first width constant portion that faces the first long side of the substrate is linearly shaped in parallel with the first long side,
a side of the second width constant portion that faces the second long side of the substrate is linearly shaped in parallel with the second long side, and
a distance between the first connection position and the second connection position is longer than a distance between the first widened portion and the second widened portion in the lateral direction.
